(19) United States
(12) Patent Application Publication
(10) Pub. No.: US 2004/0135904 A1
(43) Pub. Date: Jul. 15, 2004

(54) Image sorting method, device, and program

(76) Inventors: Kazuo Shiota, Tokyo (JP); Kiyotaka Kaneko, Kanagawa-ken (JP)

Correspondence Address: BIRCH STEWART KOLASCH & BIRCH, PO BOX 747, FALLS CHURCH, VA, 22040-0747, US

(21) Appl. No.: 10/743,038

(22) Filed: Dec. 23, 2003

(30) Foreign Application Priority Data
Dec. 27, 2002 (JP) 2002-379059

(51) Int. Cl. H04N 5/262

(52) U.S. Cl. 348/231.99

(57) ABSTRACT

A database which is used for sorting image data S0 is selected as a selected database DBs from a plurality of databases DBi connected to a network 2. In the selected database DBs, an event corresponds to a date/time. By referring to the selected database DBs based on a date/time represented by date/time data attached to the image data S0, a corresponding event which corresponds to the date/time is selected. Then, by assigning the corresponding event to the image data S0, the corresponding event is associated with the image data S0.

### BACKGROUND OF THE INVENTION

1. Field of the Invention

The present invention relates to an image sorting method and an image sorting device for sorting image data obtained by a digital camera or image data obtained by reading an image recorded on a film such as a negative film, and a program for causing a computer to execute the image sorting method.

2. Description of the Related Art

Generally, image data obtained by reading an image recorded on a negative film or image data obtained by a digital camera are organized and stored. However, as the amount of image data increases, the more troublesome organization of the image data becomes. Especially, in a case that the image data are obtained by the digital camera which requires no film cost, there is a tendency that a large amount of image data is obtained. As a result, the organization of the image data becomes extremely troublesome. Therefore, various methods have been proposed wherein the image data are automatically sorted, such as a method of sorting the image data according to the medium in which the image data are recorded or according to the film from which the image data are obtained and a method of sorting the image data into hierarchical folders for every year/month/day. In particular, a method has been proposed wherein photography date/time information which represents a date/time of photography and photography place information which represents a place of photography are associated with image data obtained by photography and the image data are sorted based on the photography date/time information and the photography place information (refer to Japanese Unexamined Patent Publication No. 2001-228528). Particularly, in Japanese Unexamined Patent Publication No. 2001-228528, a method is described wherein a correspondence table between dates and events such as New Year, a wedding anniversary, and a daughter's birthday or a correspondence table between places and place names such as Aoyama, Shinjuku, and Disneyland are referred to and the image data are sorted by determining titles for sorting the image data. By using the above-described method of automatically sorting the image data, a user can organize the image data efficiently.

In the method defined in Japanese Unexamined Patent Publication No. 2001-228528, the image data regarding a single person can be sorted according to events. However, in the case that different events happen to each person such as a father, a mother, an older son, and a younger son in a family, the image data cannot be sorted properly. For example, when an event of a school athletic festival of the older son and an event of a school talent show of the younger son were held at the same time on the same day, it is impossible to sort the image data respectively for the older son and the younger son.

### SUMMARY OF THE INVENTION

In view of the foregoing circumstances, it is an object of the present invention to make it possible to sort the image data according to various events.

An image sorting method according to the present invention includes the steps of obtaining photography date/time information from image data to which the photography date/time information representing a date/time of photography has been attached, selecting a single corresponding event which corresponds to the date/time of photography, represented by the photography date/time information from one or a plurality of selected databases selected from among a plurality of databases containing correspondent relationships between a plurality of events and a date/time of each of the events, and associating the corresponding event with the image data.

The “plurality of databases” may either exist at one spot or be scattered at a plurality of spots in a network for example.

Regarding image data obtained by a digital camera, information representing a date/time of photography, attached to tag information of the image data may be used as the “photography date/time information” as is. Meanwhile, regarding image data obtained by reading an image recorded on a film including a magnetic recording part in which magnetic information can be recorded, since photography date/time information can be recorded in the magnetic recording part of the film, the photography date/time information recorded on the film may be used as the “photography date/time information”.

Further, in the image sorting method according to the present invention, photography place information representing a place of photography has been attached to the image data. In the case that the plurality of databases include an area database showing correspondent relationships between places and area names, an area name corresponding to the place of photography, represented by the photography place information, may be selected from the area database and the selected area name may be associated with the image data.

Any information such as latitude/longitude, an address, and an area name may be used as the “photography place information” as long as they can represent the place of photography. For example, in the case that the image data are obtained by an imaging device with a function of receiving position data from a GPS satellite, the position data received from the GPS satellite may be used as the photography place information. Further, in the case that the imaging device has a function of communicating with a cellular phone communication network, the position of a communicating imaging device can be estimated based on the position of a base station in the cellular phone communication network, and information representing the position estimated in this manner may be used as the photography place information.

Regarding image data obtained by a digital camera with a GPS function, position data attached to tag information of the image data may be used as the photography place information as is. Meanwhile, regarding image data obtained by reading an image which has been photographed by a camera with a GPS means using a magnetically recordable film and has been recorded on the film, since position data can be recorded in a magnetic recording part of the film, the position data recorded on the film may be used as the photography place information.

Further, in the image sorting method according to the present invention, a subject included in the image data may be recognized, and the selected database may be selected based on the recognized subject.

The “subject” means a person, a building, a landscape, or the like which are included in the image represented by the image data.

Further, in the image sorting method according to the present invention, the selected database may be selected based on obtainer information regarding a person who has obtained the image data.

The “obtainer information” is information unique to the person, for specifying the person who has obtained the image data. The obtainer information is described in the tag information of the image data for example. A name of a device which has obtained the image data may be used as the obtainer information. In the case that the device which has obtained the image data is a cellular phone with built in camera, a telephone number or the like may be used as the obtainer information.

In the image sorting method according to the present invention, in the case that the plurality of databases include a personal database showing correspondent relationships between one or a plurality of persons and life stages of the one or plurality of persons, the selected database may be selected by referring to the personal database.

The “life stages” represent events in life, such as a birth, an entrance to an elementary school, an entrance to a junior high school, and the like regarding a certain person.

In the image sorting method according to the present invention, the plurality of databases may include a public database which has been published by a third party in the network.

The “public database” is not a database which may be used only by particular individuals. The “public database” is a database which has been published to the public so that anyone can use the database.

An image sorting device according to the present invention includes an information obtaining means for obtaining photography date/time information from image data to which the photography date/time information representing a date/time of photography has been attached, a selecting means for selecting a single corresponding event which corresponds to the date/time of photography, represented by the photography date/time information from one or a plurality of selected databases selected from among a plurality of databases containing correspondent relationships between a plurality of events and a date/time of each of the events, and an associating means for associating the corresponding event with the image data.

In the image sorting device according to the present invention, photography place information representing a place of photography has been attached to the image data. In the case that the plurality of databases include an area database showing correspondent relationships between places and area names, the selecting means may serve as a means for selecting an area name corresponding to the place of photography, represented by the photography place information from the area database, and the associating means may serve as a means for associating the selected area name with the image data.

Further, in the image sorting device according to the present invention, the selecting means may serve as a means for recognizing a subject included in the image data and selecting the selected database based on the recognized subject.

Further, in the image sorting device according to the present invention, the selecting means may serve as a means for selecting the selected database based on obtainer information regarding a person who has obtained the image data.

Further, in the image sorting device according to the present invention, in the case that the plurality of databases include a personal database showing correspondent relationships between one or a plurality of persons and life stages of the one or plurality of persons, the selecting means may serve as a means for selecting the selected database by referring to the personal database.

In the image sorting device according to the present invention, the plurality of databases may include a public database which has been published by a third party in the network.

Further, a program may be provided, for causing a computer to execute the image sorting method according to the present invention.

According to the present invention, the photography date/time information is obtained from the image data, and the single corresponding event which corresponds to the date/time of photography, represented by the photography date/time information is selected from the one or plurality of selected databases selected from the plurality of databases containing the correspondent relationships between the plurality of events and the date/time of each of the events. The selected corresponding event is associated with the image data. Therefore, by preparing various kinds of databases such as a database for each family member and a database regarding more detailed spots in a particular area, the image data can be sorted according to various events. Further, the sorted image data S0 can be enjoyed as a photo album to which a title of the corresponding event has been assigned.

Further, the photography place information representing the place of photography may be attached to the image data. In the case that the plurality of databases include the area database showing the correspondent relationships between the places and the area names, the area name which corresponds to the place of photography, represented by the photography place information is selected from the area database, and the selected area name is associated with the image data. Therefore, the image data can be sorted by associating the area name of the place of photography with the image data as well as by associating the date/time of photography with the image data.

Further, the subject included in the image data may be recognized, and the selected database selected based on the recognized subject. Therefore, the corresponding event which is appropriate for the subject can be selected from the selected database which is appropriate for the subject. Accordingly, the image data can be sorted by associating the event which is appropriate for the subject included in the image represented by the image data with the image data.

The selected database may also be selected based on the obtainer information regarding the person who has obtained the image data. Therefore, the corresponding event which is appropriate for the obtainer can be selected from the selected database which is appropriate for the obtainer. Accordingly, the image data can be sorted by associating the event which is appropriate for the obtainer of the image data with the image data.

In the case that the plurality of databases include the personal database showing the correspondent relationships between the one or plurality of persons and the life stages of the one or plurality of persons, the selected database is selected by referring to this personal database. Therefore, the corresponding event which is appropriate for the life stage of the particular person can be selected from the selected database based on the life stage of the particular person. Accordingly, the image data can be sorted by associating the event which is appropriate for the life stage of the particular person with the image data.

The plurality of databases may include the public database which has been published by a third party in the network. Therefore, various kinds of databases can be referred to. Accordingly, the image data can be sorted by associating the various events with the image data.

### BRIEF DESCRIPTION OF THE DRAWINGS

FIG. 1 is a schematic block diagram showing the configuration of an image sorting system according to an embodiment of the present invention, to which an image sorting device is applied;

FIG. 2 illustrates an example of an event database structure (No. 1);

FIG. 3 illustrates an example of the event database structure (No. 2);

FIG. 4 illustrates an example of an area database structure (No. 1);

FIG. 5 illustrates an example of the area database structure (No. 2);

FIG. 6 illustrates an example of the area database structure (No. 3);

FIG. 7 illustrates an example of the area database structure (No. 4);

FIG. 8 illustrates an example of a personal database structure;

FIG. 9 is a flow chart showing processing in the present embodiments;

FIG. 10 illustrates an example of sorting of image data; and

FIG. 11 is a schematic block diagram showing the configuration of an image sorting system according to another embodiment of the present invention, to which an image sorting device is applied.

### DESCRIPTION OF THE PREFERRED EMBODIMENTS

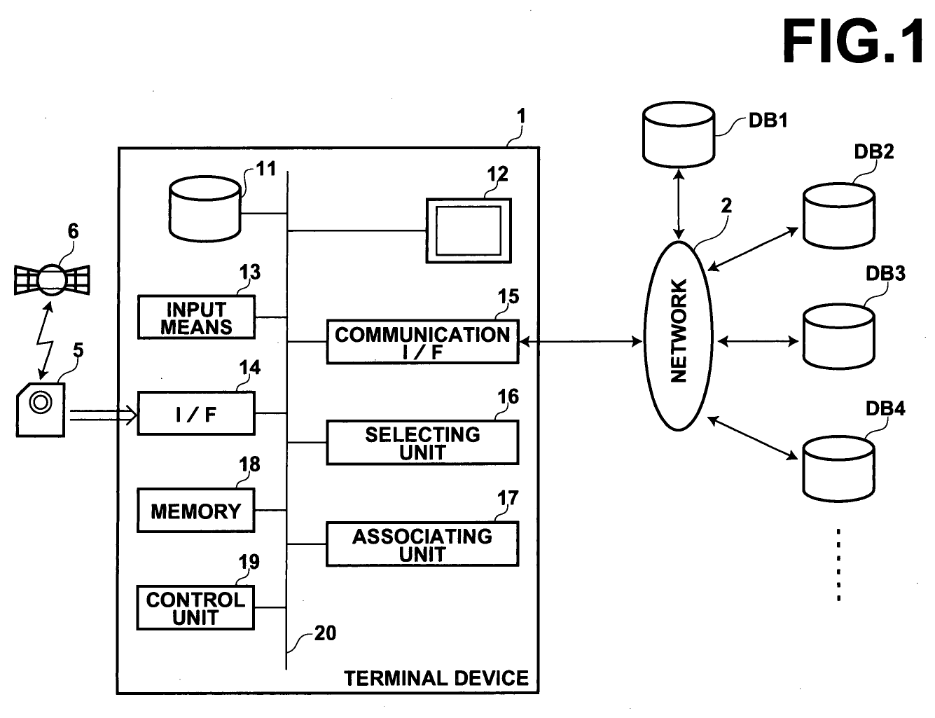

Hereinafter, embodiments of the present invention will be described with reference to drawings. FIG. 1 is a schematic block diagram showing the configuration of an image sorting system according to an embodiment of the present invention, to which an image sorting device is applied. As illustrated in FIG. 1, the image sorting system according to the present embodiment is configured by connecting a terminal device 1 such as a personal computer owned by a user who sorts image data and a plurality of databases DBi such as an event database and an area database via a network 2 such as the Internet. In the image sorting system, the terminal device 1 sorts image data S0 stored in the terminal device 1 by referring to the database DBi.

In the terminal device 1, a storing unit 11 for storing various information, a monitor 12, an input means 13 including a keyboard, a mouse, or the like, an interface 14 such as a USB or a card reader, for reading the image data from a memory card of a digital camera 5, a communication interface 15 for communicating via the network 2, a selecting unit 16 for selecting an event as will be described later, an associating unit 17 for associating the selected corresponding event with the image data, a memory 18 which serves as a work area, and a control unit 19 for controlling drive of the terminal device 1 are connected by a bus 20. The selecting unit 16 corresponds to an information obtaining means and a selecting means, and the associating unit 17 corresponds to an associating means.

A plurality of image data S0 obtained by the user of the terminal device 1 using the digital camera 5 and a personal database DBp which will be described later are stored in the storing unit 11.

In the present embodiment, the digital camera 5 carried by the user of the terminal device 1 has a function of receiving position data from a GPS satellite 6. The position data represent latitude, longitude, and altitude information at a place of photography. The position data representing the place of photography and date/time data representing the date/time of photography are attached to the image data obtained by the digital camera 5. Specifically, the position data and the date/time data are attached to the image data by describing the latitude, longitude, and altitude at the place of photography, represented by the position data, and the date/time of photography, represented by the date/time data, in tag information of the image data. The position data and the date/time data may alternatively be attached to the image data by storing the position data and the date/time data in a file separately from the image data and associating the position data and the date/time data with the image data.

A web browser is installed in the terminal device 1. The user of the terminal device 1 can refer to the database DBi by accessing the database DBi using the web browser through the communication interface 15 via the network 2.

The selecting unit 16 selects a selected database DBs from a plurality of databases DBi in the network 2, for selecting a corresponding event to be associated with the image data S0. The selected database DBs may be selected by manually inputting at the input means 13 by the user of the terminal device 1, or by recognizing a subject included in the image represented by the image data S0 and selecting a database which corresponds to the recognized subject by the selecting unit 16.

Model information of the digital camera 5 has been attached to the image data S0. In the case that the image data S0 have been obtained by a cellular phone with built in camera instead of the digital camera 5, telephone number information has been attached to the image data S0. Therefore, the model information of the camera and the telephone number information attached to the image data S0 may be used as obtainer information regarding a person who has obtained the image data S0, and a database which corresponds to the obtainer represented by the obtainer information may be selected as the selected database DBs.

Further, the selecting unit 16 selects the corresponding event by referring to the position data and the date/time data attached to the image data S0 and the selected database DBs as will be described later.

The associating unit 17 sorts the image data S0 by associating the corresponding event selected by the selecting unit 16 and a corresponding area name which will be described later with the image data S0.

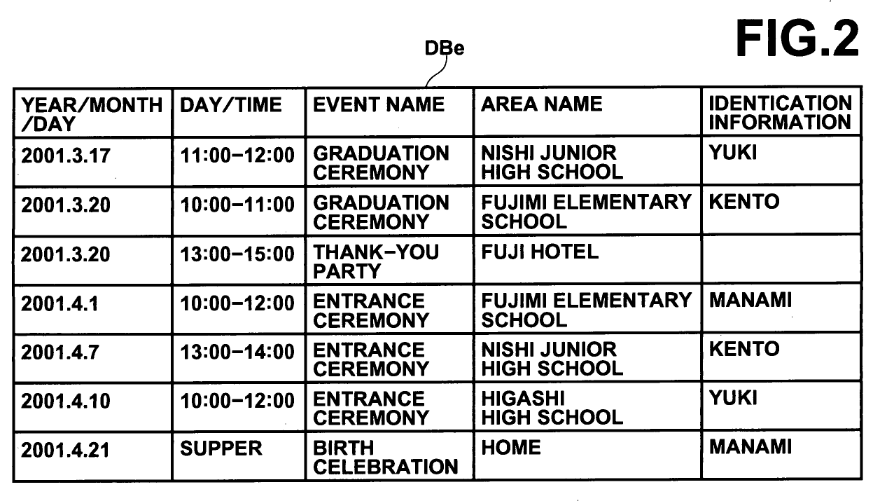

The database DBi includes the event database containing correspondent relationships between the plurality of events and the date/time of each of the events and the area database containing correspondent relationships between the plurality of events and the place of each of the events. FIG. 2 illustrates an example of an event database structure. As illustrated in FIG. 2, in the event database (hereinafter called DBe), a year/month/day, a time, and an event name correspond to each other. If required, an area name and identification information of a person related to the event further correspond to the event name in the event database.

Here, the date/time may be represented by a time period or by a vague time such as “supper”. In the latter case, the user should predefine the time period for the supper as 17:00-19:00 for example.

It is possible to know at what kind of event the image data S0 have been obtained by comparing the above-described event database DBe and the date/time of photography, represented by the date/time data attached to the image data S0. For example, if the date/time represented by the date/time data attached to the image data S0 is 14:00 on Mar. 20, 2001, the image data S0 were obtained at a thank-you party held by new graduates in honor of their teachers. Therefore, the thank-you party becomes the corresponding event which corresponds to the image data S0.

In the case that the event database DBe contains the area name, it should be judged if both of the date/time of photography, represented by the date/time data attached to the image data S0 and the place of photography, represented by the position data attached to the image data S0 match with the event database DBe. Accordingly, in the case that the image data S0 have been obtained by family members at events held in different places at the same date/time, and that the image data S0 obtained in the different places at the same date/time have been organized and stored in a memory card of the digital camera 5, the event can be associated with the image data S0 for each place.

Further, in the case that identification information of the person related to the event has been assigned to the event database DBe, the person related to the image data S0 may be specified by inputting a person's name at the terminal device 1, recognizing the subject of the image represented by the image data S0, or obtaining an ID of an imaging device 1, attached to the image data S0, which has obtained the image data S0, and the event name may be specified based on the person.

When the subject has been recognized, a recognition result may be attached to the image data S0.

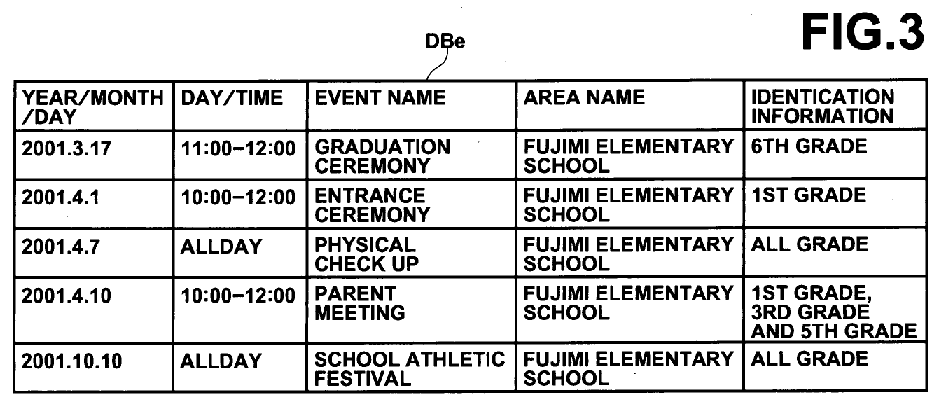

Here, the event database DBe is provided by a database provider such as a school, a public organization, and a travel agency which plans events so that anyone can refer to the event database DBe. The database provider manages the event database DBe via the network 2. The event database DBe provided by the school may be a database which contains only events unique to the school and date/times of the events corresponding to each other. Specifically, as illustrated in FIG. 3, the event database DBe provided by “Fujimi Elementary School” may be a database which shows only events of Fujimi Elementary School. For example, if the date/time represented by the date/time data attached to the image data S0 is 11:00 on Apr. 10, 2001, the image data S0 were obtained at a parent meeting of Fujimi Elementary School. Therefore, the parent meeting is selected as the corresponding event of the image data S0 by using the event database DBe illustrated in FIG. 3.

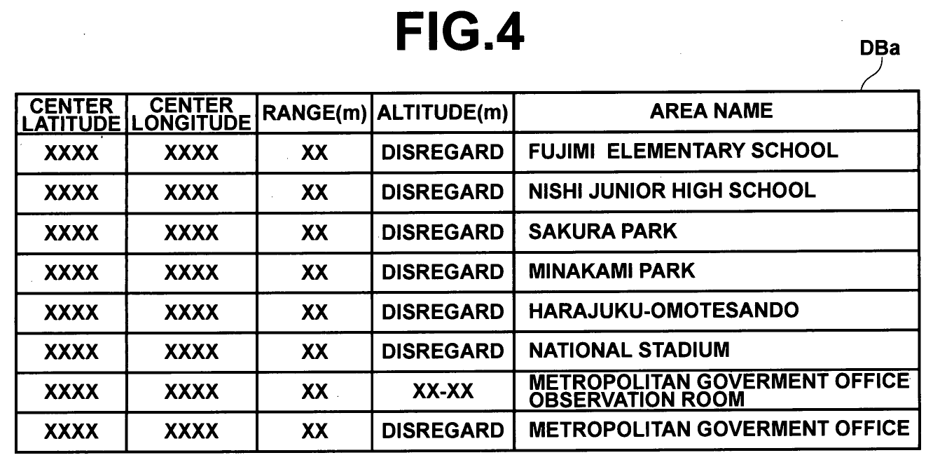

FIG. 4 illustrates an example of an area database structure. As illustrated in FIG. 4, in the area database (hereinafter called DBa), the place corresponds to the area name. The place is defined by a center latitude, a center longitude, a range in meters (m), and an altitude (m). The range means a radius of a range determined by using a center position determined by the center latitude and the center longitude as a center of the range. Term “disregard” in the area database DBa means that the area name is regarded as a corresponding area name regardless of the altitude.

As described, in the area database DBa, the area name corresponds to the altitude. Therefore, different area names can be respectively assigned to a plurality of areas (e.g., the observation floor of the Sunshine 60 building and the aquarium of the Sunshine 60 building) which are located at an identical latitude and an identical longitude but at different altitudes.

Further, the area names may be layered from a wide range to a narrow range. For example, the area names may be layered so that the East Coast and the West Coast are in a layer below the North American continent, Boston and New York are in a layer below the East Coast, and San Francisco and Los Angeles are in a layer below the West Coast.

Here, the area database DBa is referred to in connection with the event database DBe. Specifically, first, a corresponding event which corresponds to the date/time represented by the date/time data is selected by referring to the event database DBe. Further, an area name which corresponds to the latitude and the longitude represented by the position data is selected by referring to the area database DBa. For example, in the case the area database DBa illustrated in FIG. 4 is used, if the latitude and the longitude represented by the position data attached to the image data S0 correspond to Harajuku Omote-sando, the image data S0 have been obtained at Harajuku Omote-sando. Therefore, Harajuku Omote-sando is selected as the area name of the corresponding event which corresponds to the image data S0.

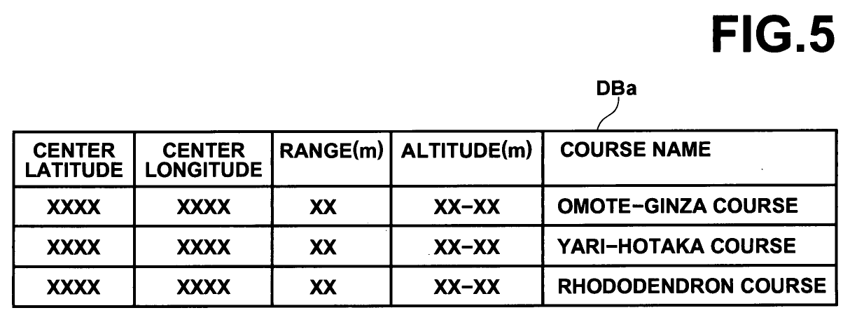

In addition to the particular areas, the area database DBa may contain area names covering a wide range, such as a sightseeing route and a mountaineering route. For example, as illustrated in FIG. 5, the area database DBa may contain a sightseeing route such as Omote-Ginza course, and mountaineering routes such as Yari-Hotaka course, and Rhododendron course as the area names.

Further, an area database DBa for sightseeing spots such as historic spots, Shikoku pilgrimage names, and one hundred distinguished mountains in Japan may be created.

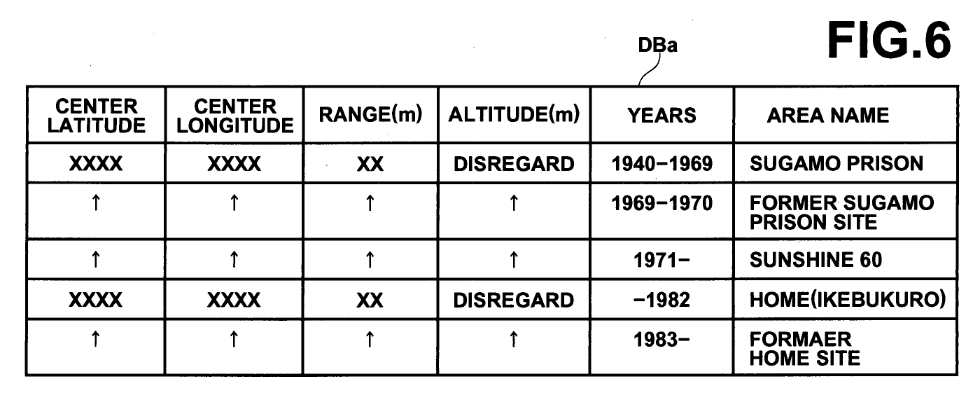

Further, when time passes, the area name may be changed, a structure may be rebuilt, a new structure may be built, or a landscape may change. Therefore, the area database DBa may contain time period information as illustrated in FIG. 6. In this case, the area name may be selected based on the date/time of photography, represented by the date/time data attached to the image data S0. For example, if the time/date of photography, attached to the image data S0 is 1969 and the center latitude and the center longitude correspond to the present Sunshine 60 building, “Former Sugamo Prison Site” is selected as the area name to be associated with the image data S0.

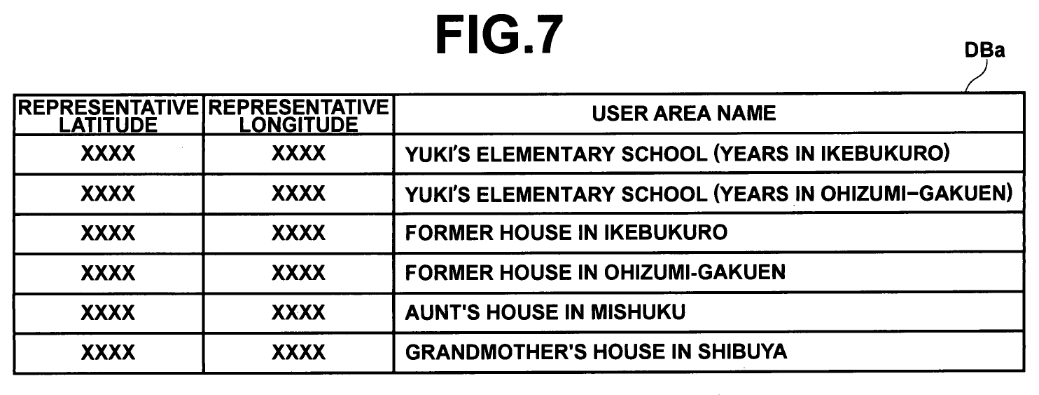

Further, as well as general names such as an elementary school, a park, and a stadium illustrated in FIG. 4 through FIG. 6, names defined by the user him/herself may be used. Generally, the user performs photography at places in his/her living area such as an elementary school or a junior high school in his/her school district or his/her home, and his/her relative's house. Further, for a company employee who often needs to move his/her home by a job transfer, his/her home place changes every time when he/she moves. Therefore, as illustrated in FIG. 7, the user may create an area database DBa containing correspondent relationships between places and area names which are defined uniquely by him/herself. In this case, the area database DBa is managed by the user.

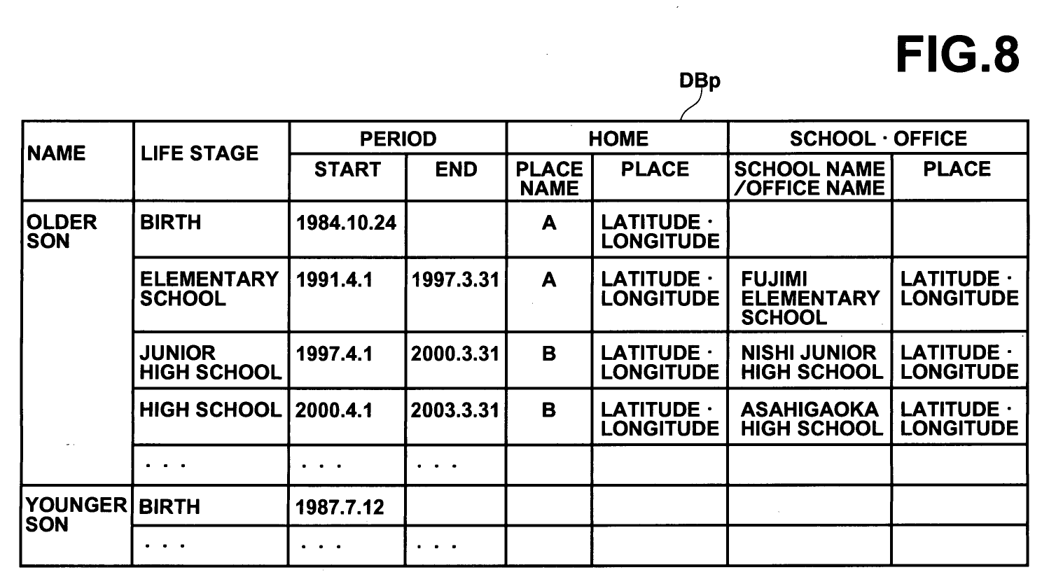

FIG. 8 illustrates an example of a personal database DBp structure. In the personal database DBp, the user and his/her family members correspond to their life stages. In the personal database DBP illustrated in FIG. 8, the family members correspond to their life stages. In the personal database DBp illustrated in FIG. 8, the older son and the younger son who are the family members correspond to the life stages, a time period, a home place, a school, and a workplace.

Here, the personal database DBp is used to select a selected database DBs used for selecting a corresponding event from the plurality of databases DBi. For example, by using the personal database DBp illustrated in FIG. 8, if the date/time represented by the date/time data attached to the image data S0 is May 5, 1992, it can be known that the image data S0 were obtained when the older son was in elementary school. In this case; by selecting the database provided by Fujimi Elementary School which is the elementary school of the older son as the selected database DBs, the event on May 5, 1992 can be selected.

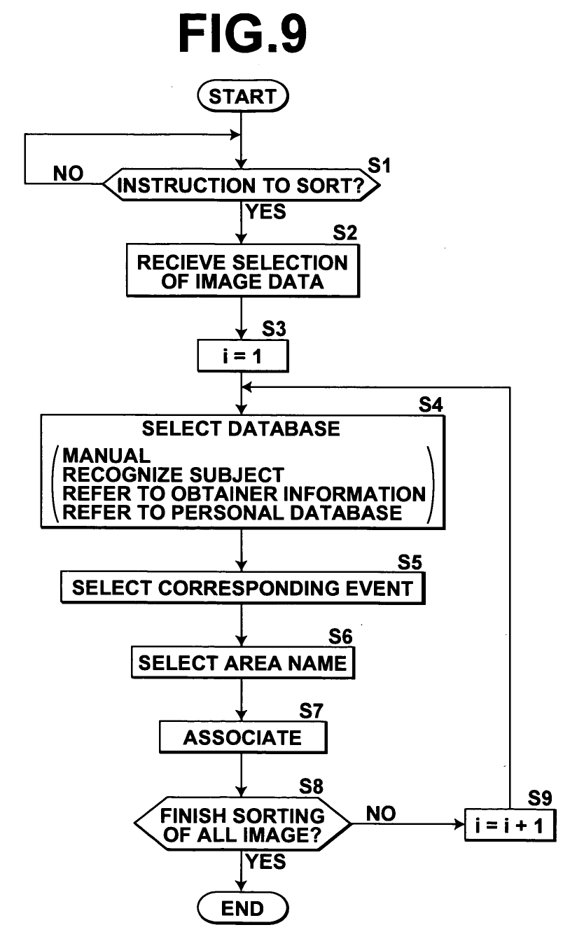

Next, processing performed in this embodiment will be described. FIG. 9 shows a flow chart of the processing performed in this embodiment. It is assumed that a plurality of image data S0 have been read from the digital camera 5 and stored in the storing unit 11. First, the selecting unit 16 monitors if the user of the terminal device 1 has issued an instruction to sort the image data S0 (step S1), and when step S1 is YES, the selecting unit 16 receives a selection of the image data (called SB) which are sorting objects (step S2). The image data are selected by inputting a file name of the image data SB from the input means 13 by the user, or by displaying a thumbnail image index of the image data S0 stored in the storing unit 11 on the monitor 12 and selecting a thumbnail image of the image data SB to be sorted from the thumbnail image index displayed on the monitor 12. Here, it is assumed that a plurality of image data SBi (i=1 ton) are selected as the sorting objects.

Next, by assuming that i=1, first image data SBi in the case that the image data SBi which are sorting objects have been sorted in file name order are set as the sorting objects (step S3). Further, a selection of the database DBs which is used for sorting the image data (hereinafter called SBi for generalization) which are the sorting objects is received (step S4). The database DBs may be selected by a manual operation by the user using the input means 13, or by recognizing the subject included in the image represented by the image data SBi, or further based on the obtainer information attached to the image data SBi.

Then, the corresponding event which corresponds to the date/time of photography, represented by the date/time data attached to the image data SBi is selected from the selected database DBs selected from the plurality of databases DBi (step S5). Further, the area name which corresponds to the place of photography, represented by the position data attached to the image data SBi is selected by referring to the area database DBa among the databases DBi (step S6).

Then, the selected corresponding event and the selected corresponding area name are associated with the image data SBi which are the sorting object (step S7). Specifically, the selected corresponding event and the selected corresponding area name are described in the tag information of the image data SBi. Then, a judgment is made if sorting of all the image data SBi has been finished (step S8). If the judgment is NO in step S8, the file name of the sorting object is changed to next image data SBi+1 (step S9), and the processing returns to step S4. When step S8 is YES, the processing ends.

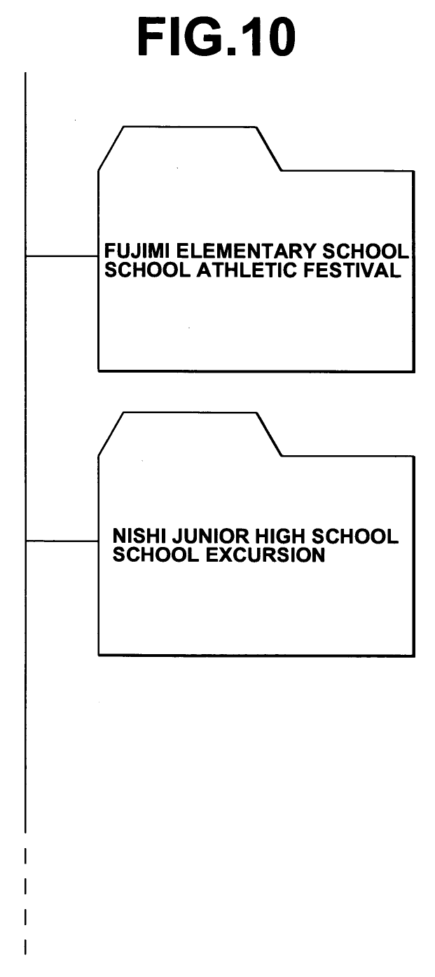

The corresponding event and the corresponding area name may be associated with the image data SBi and the image data SBi may be sorted by storing the image data SBi in a folder for the corresponding event and the corresponding area name as illustrated in FIG. 10 instead of by describing the corresponding event and the corresponding area name in the tag information of the image data SBi and associating the corresponding event and the corresponding area name with the image data SBi.

As described above, in the present embodiment, the single corresponding event which corresponds to the date/time of photography, represented by the data/time data is selected by referring to the selected database DBs selected from the databases DBi containing correspondent relationships between the plurality of events and the date/time of each of the events, and the selected corresponding event is associated with the image data. Therefore, the image data S0 can be sorted according to various events by preparing various kinds of databases DBi such as a database for each family member and a database regarding more detailed spots in a particular area. Further, the sorted image data S0 can be enjoyed as a photo album to which a title of the corresponding event has been assigned.

Further, in the case that the plurality of databases DBi include the area database DBa, the area name relating to the place of photography, represented by the position data attached to the image data S0 is selected from the area database DBa, and the selected area name is associated with the image data S0. Therefore, the image data S0 can be sorted by associating the place of photography with the image data S0 as well as by associating the date/time of photography with the image data S0.

Further, the corresponding event which is appropriate for the subject can be selected from the selected database DBs which is appropriate for the subject by recognizing the subject included in the image represented by the image data S0 and by selecting the database which corresponds to the recognized subject as the selected database DBs. Therefore, the image data can be sorted by associating the event which is appropriate for the subject included in the image represented by the image data S0 with the image data S0.

Further, in the case that the obtainer information has been attached to the image data S0, the corresponding event which is appropriate for the obtainer can be selected from the selected database DBs which is appropriate for the obtainer of the image data S0 by selecting the selected database DBs based on the obtainer information. Accordingly, the image data S0 can be sorted by associating the event which is appropriate for the obtainer of the image data S0 with the image data S0.

Further, by selecting the selected database DBs by referring to the personal database DBp, the corresponding event which is appropriate for the life stage of the particular person can be selected from the selected database DBs according to the life stage of the particular person. Accordingly, the image data S0 can be sorted by associating the event which is appropriate for the life stage of the particular person with the image data S0.

Further, by causing the plurality of databases DBi to include a public database which has been published by a third party in the network, the user of the terminal device 1 can refer to various kinds of databases. Accordingly, the image data S0 can be sorted according to various events.

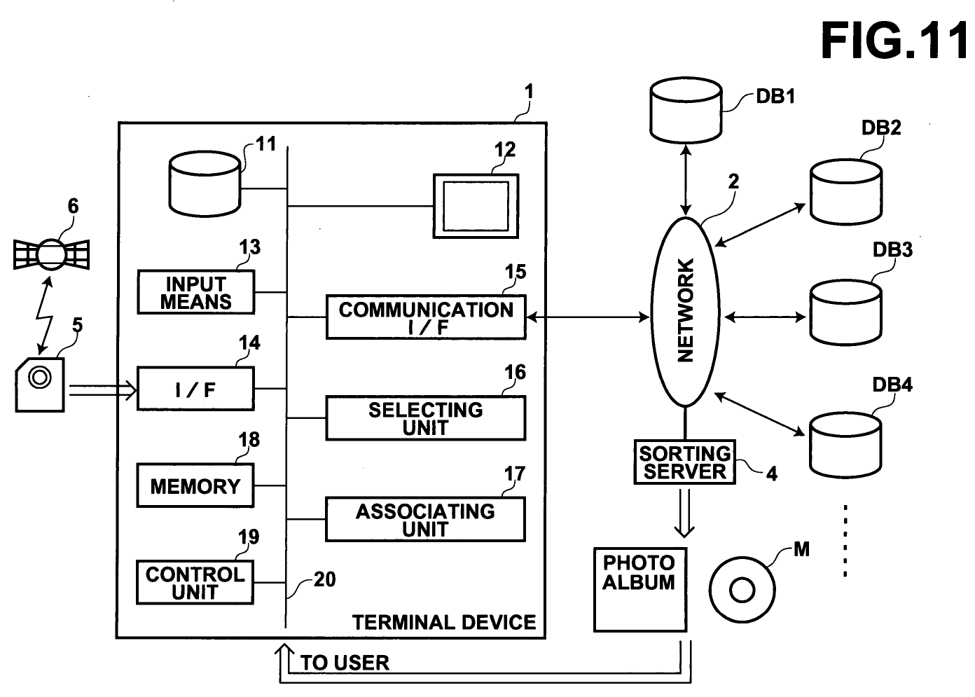

In the above embodiment, the selection of the selected database DBs, the selection of the corresponding event, and the like are performed at the terminal device 1. However, a sorting server 4 which sorts the image data S0 may be provided in the network 2 as illustrated in FIG. 11, and the selection of the selected database DBs, the selection of the corresponding event, and the like may be performed at the sorting server 4. Here, in the case that the selection of the selected database DBs, the selection of the corresponding event, and the like are performed at the sorting server 4, the image data S0 may be sent from the terminal device 1 to the sorting server 4. However, the date/time data and the position data attached to the image data S0 and information (e.g., file name) for identifying the image data S0 may be sent to the sorting server 4 and only information representing the corresponding event and the corresponding area name may be sent from the sorting server 4 to the terminal device 1. In the case that the selected database DBs is selected by recognizing the subject, the subject should be recognized at the terminal device 1, and a recognition result should be sent to the sorting server 4 together with the date/time data and the position data.

Accordingly, transmission and receipt of the image data S0 between the terminal device 1 and the sorting server 4 become unnecessary. Therefore, the image data S0 can be sorted without a risk of private image data S0 obtained by the user of the terminal device 1 being seen by others.

Obviously, the image data S0 may be sent to the sorting server 4 and sorted at the sorting server 4. In this case, if the sorting server 4 creates a photo album based on a sorting result of the image data S0 and gives a bound photo album or a photo album recorded in a medium M such as CD-R and DVD-R to the user of the terminal device 1, the user of the terminal device 1 can easily obtain the photo album created by sorting the image data S0. Further, by sending the image data S0 to the sorting server 4, the sorting server 4 can recognize the subject in a manner similar to the terminal device 1, and a recognition result can be attached to the image data S0.

Further, in the above embodiment, the area name has also been associated with the image data S0. However, the image data S0 may be sorted by associating only the corresponding event with the image data S0.

Further, in the above embodiment, the image data S0 obtained by the digital camera 5 are sorted. However, in the case that the photography is performed using a camera which records the image on a magnetic information recordable film, the date/time data and the position data are recorded on the film, and the image data, the date/time data and the position data are obtained by reading the image and the magnetic information from the film, the image data S0 can be sorted in a manner similar to the image data S0 obtained by the digital camera 5.

What is claimed is:

1. An image sorting method comprising the steps of:
obtaining photography date/time information from image data to which the photography date/time information representing a date/time of photography has been attached;
selecting a single corresponding event which corresponds to the date/time of photography, represented by the photography date/time information from one or a plurality of selected databases selected from among a plurality of databases containing correspondent relationships between a plurality of events and a date/time of each of the events; and
associating the corresponding event with the image data.

2. The image sorting method as defined in claim 1, wherein photography place information representing a place of photography has been attached to the image data, wherein in a case that the plurality of databases include an area database showing a correspondent relationship between a place and an area name, an area name corresponding to the place of photography, represented by the photography place information is selected from the area database, wherein the selected area name is associated with the image data.

3. The image sorting method as defined in claim 1, wherein a subject included in the image data is recognized, wherein the selected database is selected based on the subject recognized.

4. The image sorting method as defined in claim 1, wherein the selected database is selected based on obtainer information regarding a person who has obtained the image data.

5. The image sorting method as defined in claim 1, wherein in a case that the plurality of databases include a personal database showing a correspondent relationship between one or a plurality of persons and life stages of the one or plurality of persons, the selected database is selected by referring to the personal database.

6. The image sorting method as defined in claim 1, wherein the plurality of databases include a public database which has been published by a third party in a network.

7. An image sorting device comprising:
an information obtaining means for obtaining photography date/time information from image data to which the photography date/time information representing a date/time of photography has been attached;
a selecting means for selecting a single corresponding event which corresponds to the date/time of photography, represented by the photography date/time information from one or a plurality of selected databases selected from among a plurality of databases containing correspondent relationships between a plurality of events and a date/time of each of the events; and
an associating means for associating the corresponding event with the image data.

8. The image sorting device as defined in claim 7, wherein photography place information representing a place of photography has been attached to the image data, wherein in a case that the plurality of databases include an area database showing a correspondent relationship between a place and an area name, the selecting means is a means for selecting an area name corresponding to the place of photography, represented by the photography place information from the area database, wherein the associating means is a means for associating the area name selected with the image data.

9. The image sorting device as defined in claim 7, wherein the selecting means is a means for recognizing a subject included in the image data and selecting the selected database based on the subject recognized.

10. The image sorting device as defined in claim 7, wherein the selecting means is a means for selecting the selected database based on obtainer information regarding a person who has obtained the image data.

11. The image sorting device as defined in claim 7, wherein in a case that the plurality of databases include a personal database showing correspondent relationships between one or a plurality of persons and life stages of the one or plurality of persons, the selecting means is a means for selecting the selected database by referring to the personal database.

12. The image sorting device as defined in claim 7, wherein the plurality of databases include a public database which has been published by a third party in a network.

13. A program for causing a computer to execute an image sorting method, the program comprising the procedures of:
obtaining photography date/time information from image data to which the photography date/time information representing a date/time of photography has been attached;
selecting a single corresponding event which corresponds to the date/time of photography, represented by the photography date/time information from one or a plurality of selected databases selected from among a plurality of databases containing correspondent relationships between a plurality of events and a date/time of each of the events; and
associating the corresponding event with the image data.

14. The program as defined in claim 13, wherein photography place information representing a place of photography has been attached to the image data, wherein in a case that the plurality of databases include an area database showing a correspondent relationship between a place and an area name, the procedure of selecting is the procedure of selecting an area name corresponding to the place of photography, represented by the photography place information from the area database, wherein the procedure of associating is the procedure of associating the area name selected with the image data.

15. The program as defined in claim 13, wherein the procedure of selecting is the procedure of recognizing a subject included in the image data and selecting the selected database based on the subject recognized.

16. The program as defined in claim 13, wherein the procedure of selecting is the procedure of selecting the selected database based on obtainer information regarding a person who has obtained the image data.

17. The program as defined in claim 13, wherein in a case that the plurality of databases include a personal database showing correspondent relationships between one or a plurality of persons and life stages of the one or plurality of persons, the procedure of selecting is the procedure of selecting the selected database by referring to the personal database.
